(19) United States
(12) Patent Application Publication
(10) Pub. No.: US 2025/0141017 A1
(43) Pub. Date: May 1, 2025

(54) BATTERY CASING MODULE ASSEMBLY

(71) Applicant: GM Global Technology Operations LLC, Detroit, MI (US)

(72) Inventors: Andrew Geoffrey Balding, Wixom, MI (US); Xianfeng Yan, Clawson, MI (US)

(21) Appl. No.: 18/495,031

(22) Filed: Oct. 26, 2023

(51) Int. Cl. H01M 50/258; H01M 10/613; H01M 10/6556; H01M 50/204; H01M 50/502

(52) U.S. Cl. CPC H01M 50/258; H01M 10/613; H01M 10/6556; H01M 50/204; H01M 50/502; H01M 2220/20

(57) ABSTRACT

A battery casing module assembly includes a first battery casing module having a main body having a floor, a front wall, a rear wall, and two lateral walls delimiting a space therein configured to accept battery cells, a first abutting surface formed on a forward surface of the front wall, a first protrusion extending forward from the front wall, a second abutting surface formed on a rear surface of the rear wall, and a second protrusion extending rearward from the rear wall.

### INTRODUCTION

The subject disclosure relates to the art of rechargeable energy storage systems and, more particularly, to a battery casing.

Rechargeable energy storage systems may include different types of rechargeable energy storage cells disposed in casing. In rechargeable energy storage systems, reduction in complexity and size may be desirable.

### SUMMARY

In one exemplary embodiment, a battery casing module assembly comprises a first battery casing module comprising a main body having a floor, a front wall, a rear wall, and two lateral walls delimiting a space therein configured to accept battery cells, a first abutting surface formed on a forward surface of the front wall, a first protrusion extending forward from the front wall, a second abutting surface formed on a rear surface of the rear wall, and a second protrusion extending rearward from the rear wall.

In addition to one or more of the features described herein, the first abutting surface has a vertical height corresponding to the second protrusion, and the second abutting surface has a vertical height corresponding to the first protrusion.

In addition to one or more of the features described herein, the first abutting surface is disposed above the first protrusion, and the second abutting surface is disposed below the second protrusion.

In addition to one or more of the features described herein, a busbar trough extends between the front wall and the rear wall of the main body to separate the space in the main body into a first enclosure and a second enclosure.

In addition to one or more of the features described herein, the first enclosure and the second enclosure are structured to receive battery cells therein.

In addition to one or more of the features described herein, a cooling gallery is formed in the floor of the main body.

In addition to one or more of the features described herein, a cooling gallery cover is disposed below the floor of the main body to delimit and underside of the cooling gallery.

In addition to one or more of the features described herein, the cooling gallery is structured to have a cold cooling fluid line fluidly connected to an inlet thereof and a heated cooling fluid line fluidly connected to an outlet thereof.

In addition to one or more of the features described herein, the battery casing module assembly comprises a second battery casing module comprising a main body having a floor, a front wall, a rear wall, and two lateral walls delimiting a space therein, wherein the first battery casing module and the second battery casing module are attached.

In addition to one or more of the features described herein, the floor of the first battery casing module is attached to the floor of the second battery casing module such that the first and second battery casing modules are attached in a vertical direction.

In addition to one or more of the features described herein, a cooling gallery is formed in the floor of the main body of the first battery casing module, and the floor of the main body of the second battery casing module delimits an underside of the cooling gallery.

In addition to one or more of the features described herein, the first battery casing module and the second battery casing module are interlocked in a longitudinal direction.

In addition to one or more of the features described herein, the second battery casing module comprises a first abutting surface formed on a forward surface of the front wall and abutting the second protrusion of the first battery casing module, and a first protrusion extending forward from the front wall and abutting the second abutting surface of the first battery casing module.

In addition to one or more of the features described herein, the battery casing module assembly further comprises an end cap disposed on a lateral end of the first and second battery casing modules.

In addition to one or more of the features described herein, a cooling gallery is formed on the floor of the first battery casing module, a thermal interface material cavity is formed on the floor of the main body of the second battery casing module, and a thermal interface material is disposed in the thermal interface material cavity.

In addition to one or more of the features described herein, a cooling gallery plate is disposed between the floor of the main body of the first battery casing module and the thermal interface material.

In addition to one or more of the features described herein, a compression limiter is formed on an outer periphery of the thermal interface material cavity.

In yet another exemplary embodiment, a battery casing module structure comprises a main body having a front wall, a rear wall, two lateral walls, and a central floor delimiting an upper enclosure and a lower enclosure therein configured to accept battery cells, a first abutting surface formed on a forward surface of the front wall, a first protrusion extending forward from the front wall, a second abutting surface formed on a rear surface of the rear wall, a second protrusion extending rearward from the rear wall, a third abutting surface formed on the forward surface of the front wall below the first protrusion, a third protrusion extending forward from the front wall below the third abutting surface, a fourth protrusion extending rearward from the rear wall below the second abutting surface, and a fourth abutting surface formed on the rear surface of the rear wall below the fourth protrusion.

In addition to one or more of the features described herein, a cooling gallery is formed in the central floor.

In yet another exemplary embodiment, a battery casing module assembly comprises a first battery casing module, a second battery casing module, a third battery casing module, and a fourth battery casing module, wherein each of the first and third battery casing modules comprises a main body having a floor, a front wall, a rear wall, and two lateral walls delimiting a space therein configured to accept battery cells, a first abutting surface formed on a forward surface of the front wall, a first protrusion extending forward from the front wall, a second abutting surface formed on a rear surface of the rear wall, and a second protrusion extending rearward from the rear wall, wherein each of the second and fourth battery casing modules comprises a main body having a floor, a front wall, a rear wall, and two lateral walls delimiting a space therein configured to accept battery cells, a first abutting surface formed on a rear surface of the rear wall, a first protrusion extending rearward from the rear wall, a second abutting surface formed on a front surface of the front wall, and a second protrusion extending forward from the front wall, wherein the floor of the first battery casing module is attached to the floor of the second battery casing module such that the first and second battery casing modules are attached in a vertical direction, wherein the floor of the third battery casing module is attached to the floor of the fourth battery casing module such that the third and fourth battery casing modules are attached in the vertical direction, wherein the first abutting surface of the third battery casing module abuts the second protrusion of the first battery casing module, wherein the first protrusion of the third battery casing module abuts the second abutting surface of the first battery casing module, wherein the second abutting surface of the fourth battery casing module abuts the first protrusion of the third battery casing module, wherein the second protrusion of the fourth battery casing module abuts the first abutting surface of the third battery casing module, and wherein a first cooling gallery is formed in the floor of the first battery casing module and a second cooling gallery is formed in the floor of the third battery casing module.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a is a left side view of a vehicle including a battery pack with a battery casing module assembly according to a non-limiting example;

FIG. 2 is a top front perspective view of a battery casing module according to a non-limiting example;

FIG. 3 is a top rear perspective view of battery casing modules that are stacked in a vertical direction according to a non-limiting example;

FIG. 4 is a top front perspective view of battery casing modules that are stacked in a longitudinal direction according to a non-limiting example;

FIG. 5 is a side view of the battery casing modules of FIG. 4;

FIG. 6 is a top front perspective view of the battery casing modules of FIG. 4 with battery cells disposed therein according to a non-limiting example;

FIG. 7 is a top front perspective view of the battery casing modules of FIG. 4 with end caps disposed thereon according to a non-limiting example;

FIG. 8 is a front view of the battery casing modules of FIG. 4 with end caps disposed thereon according to a non-limiting example;

FIG. 9 is a top front perspective view of the battery casing modules of FIG. 6 with cooling fluid lines disposed thereon according to a non-limiting example;

FIG. 10 is a bottom front perspective view of a battery casing module having a cooling fluid gallery formed thereon according to a non-limiting example;

FIG. 11 is a perspective view of the battery casing module of FIG. 10 vertically inverted according to a non-limiting example;

FIG. 12 is a top view of battery casing modules stacked in the vertical direction and having a cooling fluid gallery formed thereon according to a non-limiting example;

FIG. 13 is a cross-sectional view of the battery casing modules of FIG. 12 taken along XIII-XIII according to a non-limiting example; and

FIG. 14 is a top perspective view of a battery casing module structure formed by vertically stacked battery casing modules that are integrally formed as a unitary structure with a lateral portion removed according to a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

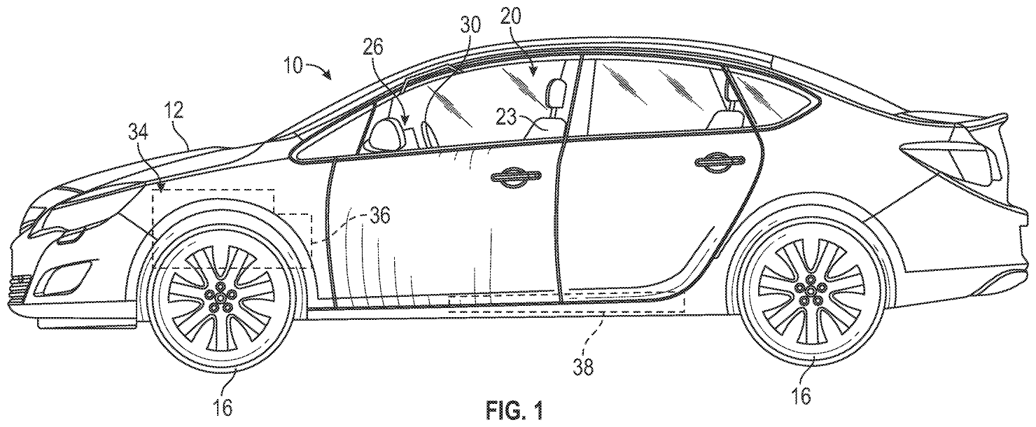

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

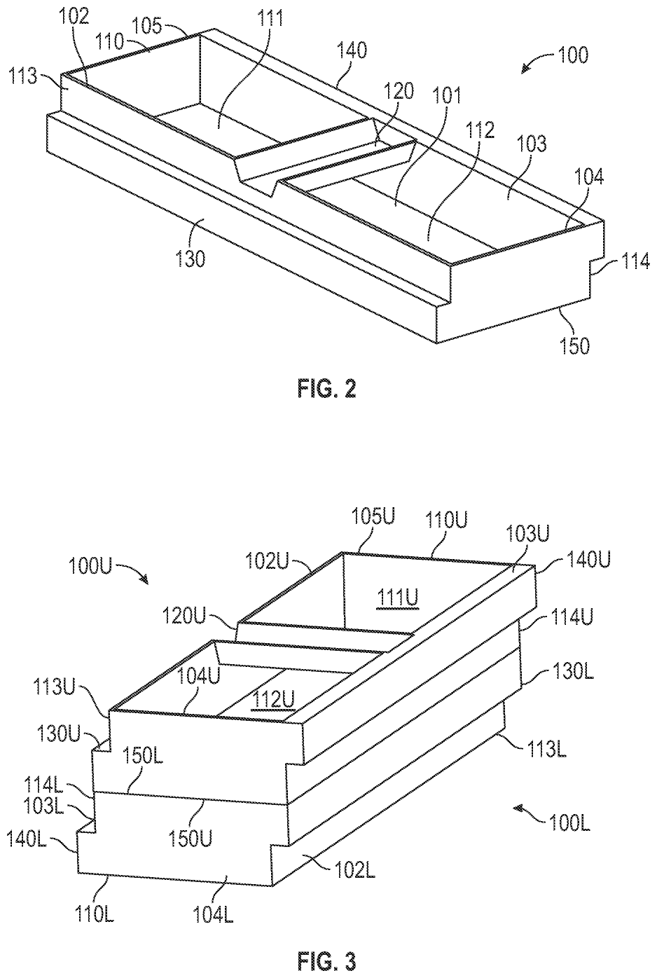

The vehicle 10 includes an electric motor 34 connected to a transmission 36 that provides power to one or more of the plurality of wheels 16. A rechargeable energy storage system 38 is arranged in the body 12 and provides power to the electric motor 34. While specific locations are shown for the electric motor 34, the transmission 36, and the rechargeable energy storage system 38 in FIG. 1, these locations are merely exemplary and not limiting, and locations of these structures may vary. According to one or more embodiments, the rechargeable energy storage system 38 includes a modular battery casing including a battery casing module 100 shown in FIGS. 2-14.

FIG. 2 shows a battery casing module 100 according to one or more embodiments. The battery casing module 100 may include a main body 110 with a floor 101, front wall 102, rear wall 103, and side walls 104, 105 delimiting a space therein. A busbar trough 120 extends between the front wall 102 and the rear wall 103 and divides the space delimited by the main body 110 into a first enclosure 111 and a second enclosure 112. The front wall 102 of the main body 110 includes a first abutting surface 113 at a top portion thereof and first protrusion 130 extending forward from a bottom portion thereof. The rear wall 103 of the main body 110 includes a second abutting surface 114 at a bottom portion thereof and second protrusion 140 extending rearward from a top portion thereof. The floor 101 of the main body 110 includes a bottom surface 150. According to one or more embodiments, the battery casing module 100 is formed as a unitary structure. According to one or more embodiments, the battery casing module 100 may be formed as a unitary structure of cast Aluminum. According to one or more embodiments, the battery casing module 100 may be formed by a composite material. According to one or more embodiments, the battery casing module 100 may be formed as a unitary structure of a molded composite material.

The first enclosure 111 and the second enclosure 112 may be structured to receive battery cells therein. For example, the first enclosure 111 and the second enclosure 112 may receive pouch cells, prismatic cells, cylindrical cells, or other battery cells known in the art. The battery cells may be tabbed or tabless. Further, while FIG. 2 shows the busbar trough 120 separating the space delimited by the main body 110 into the first enclosure 111 and the second enclosures 112, the battery casing module 100 may instead include a single large enclosure within the main body 110. While not shown, a cover may be disposed atop the battery casing module 100 to close the first enclosure 111 and the second enclosure 112 or the single large enclosure.

FIG. 3 shows an upper battery casing module 100U and a lower battery casing module 100L that are stacked in a vertical direction according to one or more embodiments.

The upper battery casing module 100U may include a main body 110U with a floor 101U, a front wall 102U, a rear wall 103U, and side walls 104U, 105U delimiting a space therein. A busbar trough 120U extends between the front wall 102U and the rear wall 103U and divides the space delimited by the main body 110U into a first enclosure 111U and a second enclosure 112U. The front wall 102U of the main body 110U includes a first abutting surface 113U at a top portion thereof and first protrusion 130U extending forward from a bottom portion thereof. The rear wall 103U of the main body 110U includes a second abutting surface 114U at a bottom portion thereof and second protrusion 140U extending rearward from a top portion thereof. The floor 101U of the main body 110U includes a bottom surface 150U. According to one or more embodiments, the upper battery casing module 100U is formed as a unitary structure. According to one or more embodiments, the upper battery casing module 100U is formed as a unitary structure of cast Aluminum. According to one or more embodiments, the upper battery casing module 100U may be formed by a composite material. According to one or more embodiments, the upper battery casing module 100U may be formed as a unitary structure of a molded composite material.

The first enclosure 111U and the second enclosure 112U of the upper battery casing module 100U may be structured to receive battery cells therein. For example, the first enclosure 111U and the second enclosure 112U may receive pouch cells, prismatic cells, cylindrical cells, or other battery cells known in the art. The battery cells may be tabbed or tabless. Further, while FIG. 3 shows the busbar trough 120U separating the space delimited by the main body 110U into a first enclosure 111U and a second enclosure 112U, the upper battery casing module 100U may instead include a single large enclosure within the main body 110U. While not shown, a cover may be disposed atop the upper battery casing module 100U to close the first enclosure 111U and the second enclosure 112U or the single large enclosure.

The lower battery casing module 100L may be structurally similar to the upper battery casing module 100U but vertically inverted. The lower casing module 100L may include a main body 110L. While the inner structure of the main body 110L is not visible in FIG. 3, the main body 110L of the lower battery casing module 100L is structured similarly to main body 110U of the upper battery casing module 100U. That is, the main body 110L also includes a floor 101L, a front wall 102L, a rear wall 103L, and side walls 104L, 105L delimiting a space therein, and a busbar trough extending between the front wall 102L and the rear wall 103L and dividing the space delimited by the main body 110L into a first enclosure and a second enclosure. As the lower battery casing module 100L is vertically inverted, the vertical and longitudinal directions are also inverted.

The rear wall 103L of the main body 110L includes a first abutting surface 113L at a bottom portion thereof and first protrusion 130L extending rearward from a top portion thereof. The front wall 102L of the main body 110L includes a second abutting surface 114L at a top portion thereof and second protrusion 140L extending forward from a bottom portion thereof. The floor 101L of the main body 110L includes a top surface 150L. According to one or more embodiments, the lower battery casing module 100L is formed as a unitary structure. According to one or more embodiments, the lower battery casing module 100L is formed as a unitary structure of cast Aluminum. According to one or more embodiments, the lower battery casing module 100L may be formed by a composite material. According to one or more embodiments, the lower battery casing module 100L may be formed as a unitary structure of a molded composite material.

The first enclosure and the second enclosure (not shown) of the lower battery casing module 100L may be structured to receive battery cells therein. For example, the first enclosure and the second enclosure may receive pouch cells, prismatic cells, cylindrical cells, or other battery cells known in the art. The battery cells may be tabbed or tabless. Further, the lower battery casing module 100L may include a single large enclosure within the main body 110L. While not shown, a cover may be disposed below the lower battery casing module 100L to close the first enclosure and the second enclosure or the single large enclosure.

As shown in FIG. 3, the upper battery casing module 100U may be attached to the lower battery casing module 100L with the bottom surface 150U abutting the top surface 150L. According to one or more embodiments, the upper battery casing module 100U may be bolted to the lower battery casing module 100L. According to one or more embodiments, the upper battery casing module 100U may be welded to the lower battery casing module 100L. The upper battery casing module 100U may be attached to the lower battery casing module 100L by other attachment mechanisms known in the art. According to one or more embodiments, the upper battery casing module 100U and the lower battery casing module 100L may be formed as a unitary structure instead of two separate structures that are attached to each other.

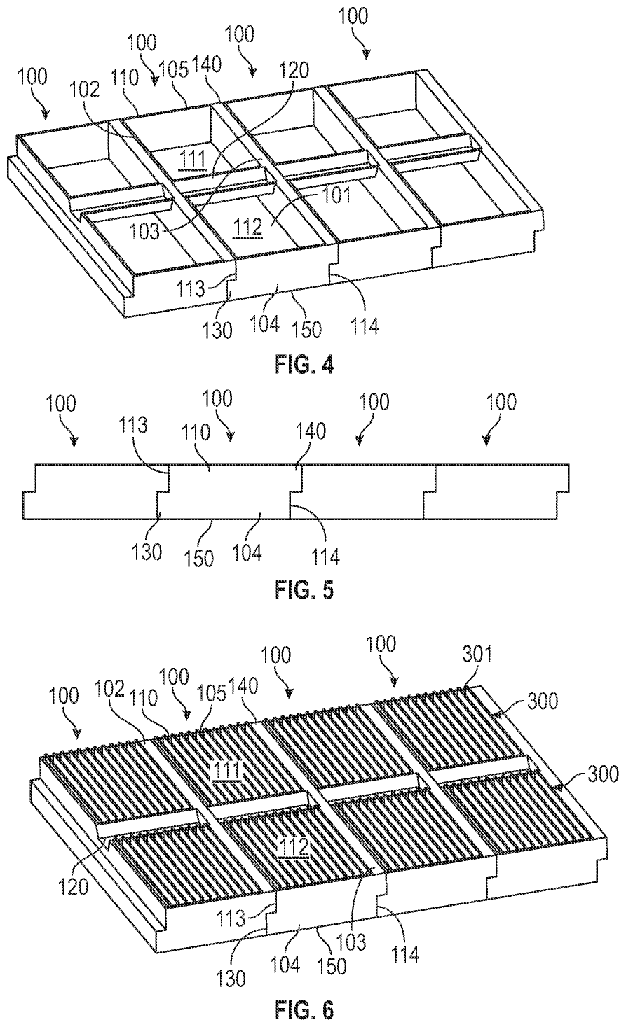

FIGS. 4-6 show battery casing modules 100 that are stacked in a longitudinal direction according to one or more embodiments. Each of the battery casing modules 100 may be similar to that shown in FIG. 2 and described above. According to one or more embodiments, the first protrusion 130 may have a similar or identical height as the second abutting surface 114 and the second protrusion 140 may have a similar or identical height as the first abutting surface 113. Multiple battery casing modules 100 may be stacked in the longitudinal direction such that the first protrusion 130 of a battery casing module 100 may abut the second abutting surface 114 of an adjacent battery casing module in the forward direction and the second protrusion 140 of the battery casing module 100 may abut the first abutting surface 113 of an adjacent battery casing module 100 in the rearward direction. Thus, multiple battery casing modules 100 may be interlocked together in the longitudinal direction. In addition to the interlocking, the battery casing modules 100 may be attached together by, for example, bolting them together, welding them together, or other attachment mechanisms known in the art. Although FIGS. 4-6 show four battery casing modules 100 interlocked together, there may be any number of battery casing modules 100 interlocked.

According to one or more embodiments, multiple vertically stacked upper and lower battery casing modules 100U, 100L shown in FIG. 3 may be interlocked and/or attached together in a similar manner as described above. As shown in FIG. 6, a battery cell stack 300 that includes a plurality of battery cells 301 may be received in the first enclosure 111 and the second enclosure 112 of each of the battery casing modules 100. According to one or more embodiments, while not shown, a cover may be disposed on each of the battery casing modules 100 to close the first enclosure 111 and the second enclosure 112. According to one or more embodiments, one cover may be disposed on multiple interlocked battery casing modules 100.

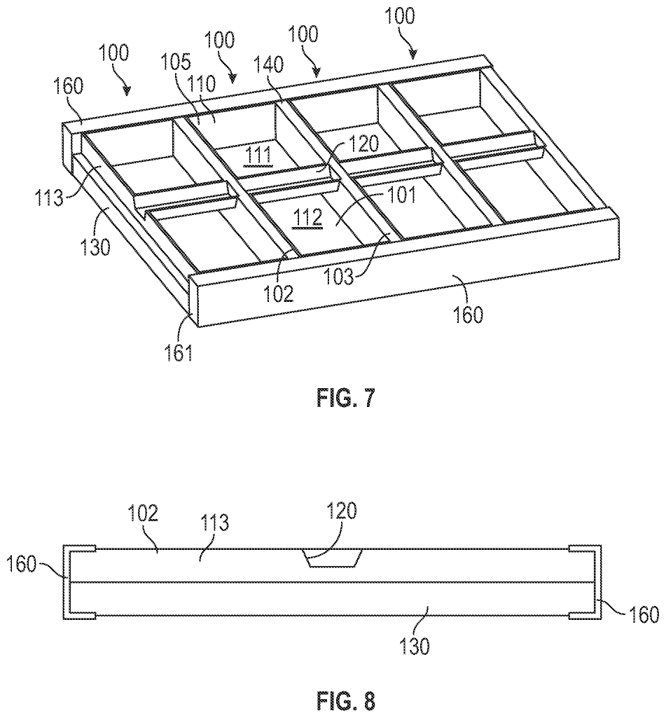

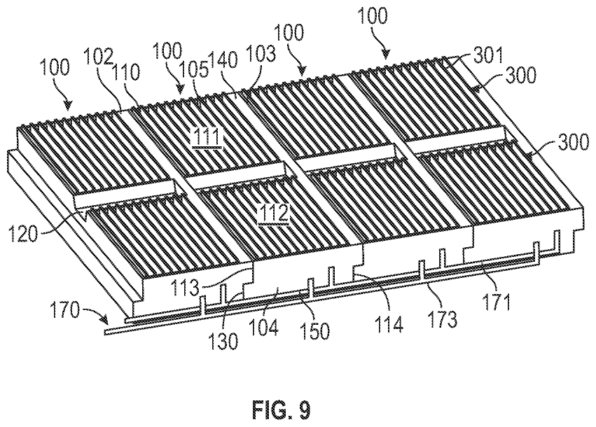

FIGS. 7-8 show the battery casing modules 100 of FIG. 4 with end caps 160 disposed on lateral ends thereof. The end caps 160 may surround opposite lateral ends of the main body 110 of each of the battery casing modules 100 to help keep the battery casing modules 100 interlocked. The end caps 160 may help protect lateral ends of the battery casing modules 100. The end caps 160 may provide additional strength and/or stiffness to the battery casing modules 100. According to one or more embodiments, the end caps 160 may be formed of the same material as the battery casing modules 100. According to one or more embodiments, the end caps 160 may be formed of Aluminum. According to one or more embodiments, the end caps 160 may be formed of a different material from the battery casing modules. According to one or more embodiments, the end caps 160 may be formed of an elastic material. According to one or more embodiments, the end caps 160 may be formed of rubber or plastic. The end caps 160 may be closed on the longitudinal ends 161 as shown in FIG. 7 or open on the longitudinal ends as shown in FIG. 8.

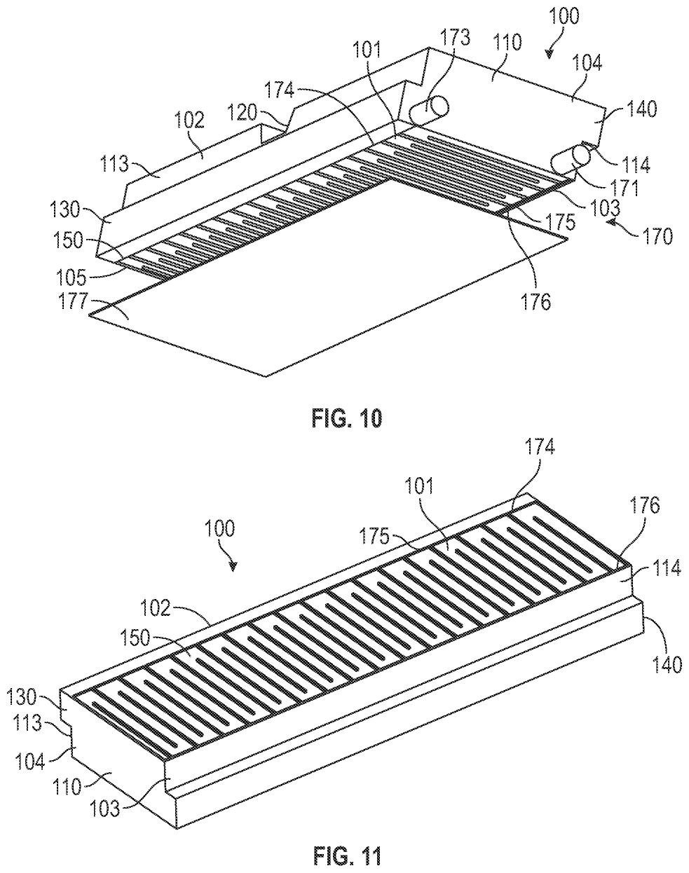

FIG. 9 shows the battery casing modules 100 of FIG. 6 schematically showing cooling fluid lines 170 fluidly connected to the battery casing modules 100, and FIGS. 10-11 show a cooling gallery 175 formed on the bottom surface 150 of the floor 101 of the main body 110 of the battery casing module 100. According to one or more embodiments, the cooling gallery 175 may be a flowpath formed in the bottom surface 150. The cooling gallery 175 may be formed on each of the battery casing modules 100. As shown in FIG. 11, the cooling gallery 175 may be delimited on one longitudinal end by an adjacent battery casing module 100. As a non-limiting example, a forward end 174 of the cooling gallery 175 may be delimited within the battery casing module 100, while a rear end 176 of the cooling gallery 175 may be delimited by a bottom end of the first protrusion 130 of an adjacent battery casing module 100. According to one or more embodiments, as shown in FIG. 10, a cooling gallery cover 177 may be disposed below the bottom surface 150 to delimit an underside of the cooling gallery 175. According to one or more embodiments, instead of a cooling gallery cover 177, a vertically inverted battery casing module 100 may delimit the underside of the cooling gallery 175.

The cooling fluid lines 170 include a cold cooling fluid line 171 and a heated cooling fluid line 173. The cold cooling fluid line 171 is fluidly connected to the inlet of a cooling gallery 175 on the bottom surface 150 of the floor 101 of the main body 110 of each of the battery casing modules 100, and the heated cooling fluid line 173 is fluidly connected to the outlet of a cooling gallery 175 on the bottom surface 150 of the floor 101 of the main body 110 of each of the battery casing modules 100. When the battery cells 301 emit heat during use, the cold cooling fluid flows into the inlet of the cooling gallery 175 of each of the battery casing modules 100 through the cold cooling fluid line 171 and cools the floor 101 of the main body 110, which in turn cools the remainder of the battery casing module 100 via conduction. The cooling fluid heated by the heat emitted by the battery cells 301 flows out of an outlet of the cooling gallery 175 to the heated cooling fluid line 173 to be cooled, for example by a heat exchanger, and cycled back into the cold cooling fluid line 171.

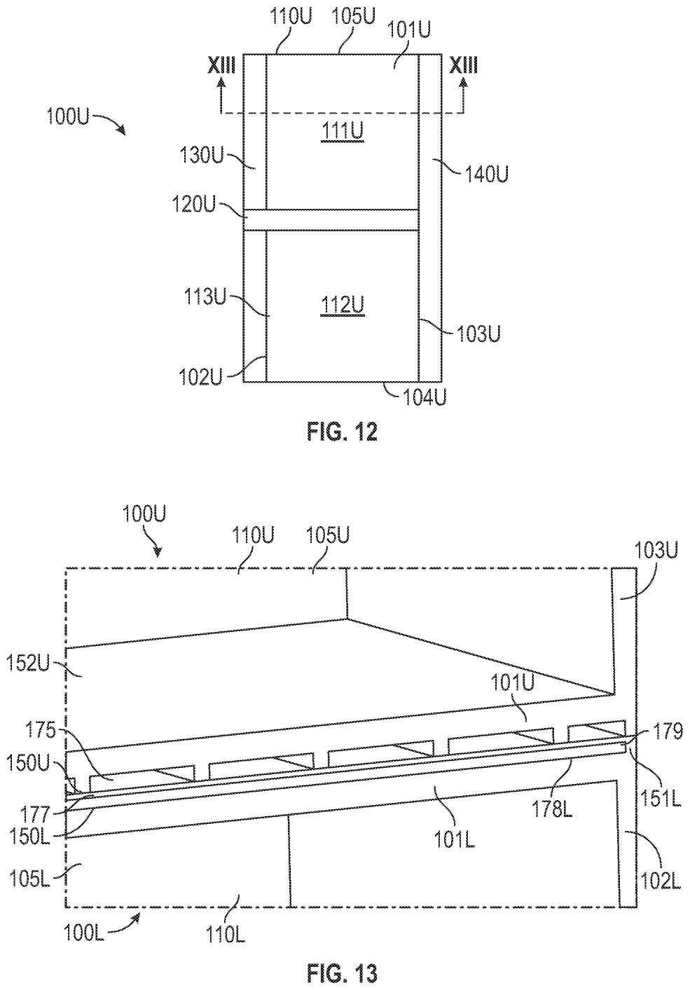

FIG. 12 shows a top view of an upper battery casing module 100U stacked vertically above a lower battery casing module 100L, and FIG. 13 shows a cross-sectional view of the upper battery casing module 100U and the lower battery casing module 100L taken at 13-13 in FIG. 12. As with the embodiment shown in FIG. 3, the bottom surface 150U of the floor 101U of the main body 110U of the upper battery casing module 100U is attached to a top surface 150L of the floor 101L of the main body 110L of the lower battery casing module 100L. According to one or more embodiments, the main body 110U of the upper battery casing module 100U may further have a cooling plate 152U disposed on the floor 101U thereof. The bottom surface 150U may further have a cooling gallery 175 formed therein. According to one or more embodiments, the cooling gallery 175 may be similar to that shown in FIGS. 10-11. A cooling gallery cover 177 may be disposed below the bottom surface 150U so as to delimit the underside of the cooling gallery 175. While FIG. 13 shows the cooling gallery cover 177 being separate from the upper battery casing module 100U and the lower battery casing module 100L, according to one or more embodiments, the cooling gallery cover 177 may be formed as part of the upper battery casing module 100U or the lower battery casing module 100L. The top surface 150L of the floor 101L of the main body 110L of the lower battery casing module 100L may include a thermal interface material cavity 178L that may receive a thermal interface material 179 that helps conduct heat. According to one or more embodiments, the thermal interface material 179 may also function as an adhesive. A compression limiter 151L may be formed on the lateral sides of the thermal interface material cavity 178L that provides structural integrity so that compression of the thermal interface material 179 is limited or prevented.

According to one or more embodiments, the peripheries of the upper battery casing module 100U and the lower battery casing module 100L may be welded together. According to one or more embodiments, a thermal interface material may be omitted.

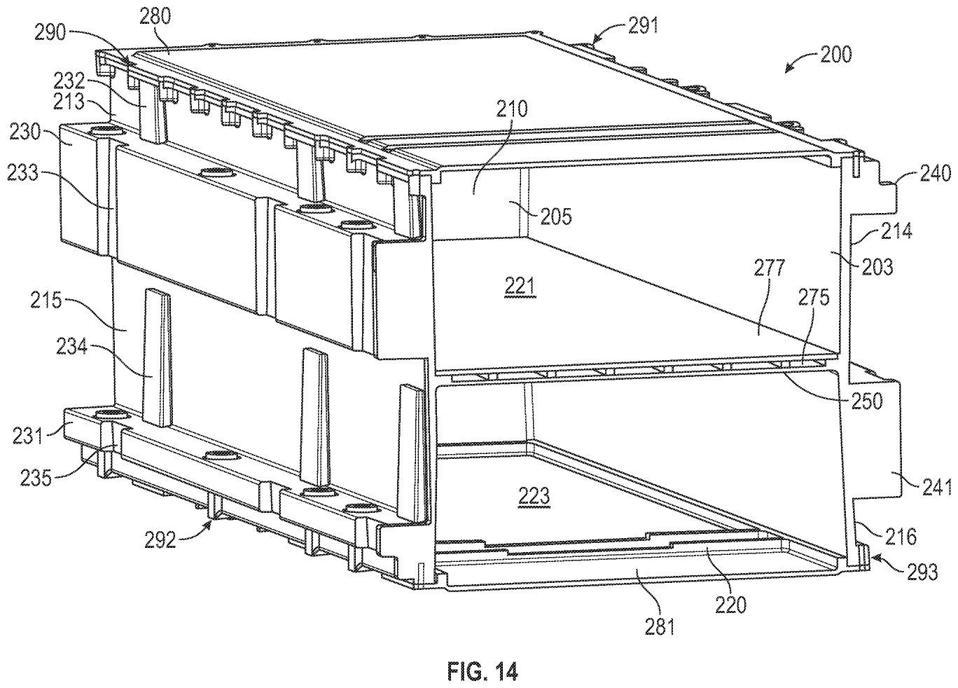

FIG. 14 shows a battery casing module structure 200 formed by vertically stacked battery casing modules that are integrally formed as a unitary structure according to one or more embodiments. One lateral end of the battery casing module structure 200 has been removed to show the inner components thereof. While only one battery casing module structure 200 is shown in FIG. 14, multiple battery casing module structures 200 may be interlocked in the longitudinal direction similarly to the battery casing modules 100 shown in FIG. 4.

The battery casing module structure 200 may include a main body 210 with a front wall 202, a rear wall 203, and side walls 204 delimiting a space therein as well as a central floor 250 that is disposed at or near a vertical center of the battery casing module structure 200. One of the side walls is not shown in FIG. 14 as a lateral end of the battery casing module structure 200 has been removed as noted above. The central floor 250 may separate the space delimited by the front wall 202, the rear wall 203, and the side walls 204 of the main body 210 into an upper enclosure 221 and a lower enclosure 223.

The front wall 202 of the main body 210 includes a first abutting surface 213 at a top portion thereof, a first protrusion 230 below the first abutting surface 213 and extending forward, a third abutting surface 215 below the first protrusion 230, and a third protrusion 231 below the third abutting surface 215 and extending forward. According to one or more embodiments, the first and third abutting surfaces 213, 215 have differing heights in the vertical direction, and first and third protrusions 230, 231 have differing heights in the vertical direction. The rear wall 203 of the main body 210 includes a second protrusion 240 at a top portion thereof and extending rearward, a second abutting surface 214 below the second protrusion 240, a fourth protrusion 241 below the second abutting surface 214 and extending rearward, and a fourth abutting surface 216 below the fourth protrusion 241. When a plurality of battery casing module structures 200 are interlocked in the longitudinal direction, the first protrusion 230 of a battery casing module structure 200 may abut the second abutting surface 214 of an adjacent battery casing module structure 200, the second protrusion 240 of a battery casing module structure 200 may abut the first abutting surface 213 of an adjacent battery casing module structure 200, the third protrusion 231 of a battery casing module structure 200 may abut the fourth abutting surface 216 of an adjacent battery casing module structure 200, and the fourth protrusion 241 of a battery casing module structure 200 may abut the third abutting surface 215 of an adjacent battery casing module structure 200.

According to one or more embodiments, the first and third abutting surfaces 213, 215 may include a plurality of keying structures 232, 234, and the first and third protrusions 230, 231 may include a plurality of keying structures 233, 235. While FIG. 14 shows the keying structures 232, 234 of the first and third abutting surfaces 213, 215 being protrusions and the keying structures 233, 235 of the first and third protrusions 230, 231 being recesses, the keying structures 222, 233, 234, 235 are not limited thereto. While not shown, according to one or more embodiments, the second and fourth abutting surfaces 214, 216 may include a plurality of keying structures that are structured to engage with the keying structures 233, 235 of the first and third protrusions 230, 231 of an adjacent battery casing module structure 200, and the second and fourth protrusions 240, 241 may include a plurality of keying structures that are structured to engage with the keying structures 232, 234 of the first and third abutting surfaces 213, 215 of an adjacent battery casing module structure 200.

The upper enclosure 221 and the lower enclosure 223 may be structured to receive battery cells therein. A top cover plate 280 may be disposed at a top end of the main body 210 to close the upper enclosure 221, and a bottom cover plate 281 may be disposed at a bottom end of the main body 210 to close the lower enclosure 223. A busbar trough 220 may be formed on the top cover plate 280 to separate the upper enclosure 221 into a first upper enclosure and a second upper enclosure, and busbar trough 220 may be formed on the bottom cover plate 281 to separate the lower enclosure 223 into a first lower enclosure and a second lower enclosure. According to one or more embodiments, bus bar troughs may instead be formed on the main body 210 similarly to the busbar trough 120 shown in FIG. 2. The first upper enclosure, the second upper enclosure, the first lower enclosure, and the second lower enclosure may be structured to receive battery cells therein.

The front top edge of main body 210 and/or the top cover plate 280 may include keying structures 290, and the rear top edge of the main body 210 and/or the top cover plate 280 include keying structures 291. The keying structures 290 of the battery casing module structure 200 are structured to engage with the keying structures 291 of an adjacent battery casing module structure 200.

The bottom top edge of main body 210 and/or the bottom cover plate 281 may include keying structures 292, and the rear bottom edge of the main body 210 and/or the bottom cover plate 281 include keying structures 293. The keying structures 292 of the battery casing module structure 200 are structured to engage with the keying structures 293 of an adjacent battery casing module structure 200

According to one or more embodiments, a cooling gallery 275 may be formed in the central floor 250. The cooling gallery 275 may be structured and function similarly to the cooling gallery 275 shown in FIGS. 10-11. A cooling gallery cover 277 may be disposed above the central floor 250 to delimit a top side of the cooling gallery 275.

According to one or more embodiments, the main body 210 is formed as a unitary structure. According to one or more embodiments, the main body 210 is formed as a unitary structure of cast Aluminum. According to one or more embodiments, the main body 210 may be formed by a composite material. According to one or more embodiments, the main body 210 may be formed as a unitary structure of a molded composite material.

According to one or more embodiments, an assembly including a battery casing module(s) 100, upper and lower battery casing modules 100U, 100L, and a battery casing module structure(s) 200 may be referred to as a battery casing module assembly. According to one or more embodiments, the battery casing modules 100, the upper and lower battery casing modules 100U, 100L, and battery casing module structure 200 as described above may reduce complexity, may reduce tolerance stack, may reduce overall stack height, and/or may result in a compact and versatile assembly compatible with venting solutions and/or low profile packaging envelopes.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery casing module assembly comprising:
a first battery casing module, comprising:
a main body having a floor, a front wall, a rear wall, and two lateral walls delimiting a space therein configured to accept battery cells;
a first abutting surface formed on a forward surface of the front wall;
a first protrusion extending forward from the front wall;
a second abutting surface formed on a rear surface of the rear wall; and
a second protrusion extending rearward from the rear wall.

2. The battery casing module assembly of claim 1, wherein the first abutting surface has a vertical height corresponding to the second protrusion, and the second abutting surface has a vertical height corresponding to the first protrusion.

3. The battery casing module assembly of claim 1, wherein the first abutting surface is disposed above the first protrusion, and the second abutting surface is disposed below the second protrusion.

4. The battery casing module assembly of claim 1, wherein a busbar trough extends between the front wall and the rear wall of the main body to separate the space in the main body into a first enclosure and a second enclosure.

5. The battery casing module assembly of claim 4, wherein the first enclosure and the second enclosure are structured to receive battery cells therein.

6. The battery casing module assembly of claim 1, wherein a cooling gallery is formed in the floor of the main body.

7. The battery casing module assembly of claim 6, wherein a cooling gallery cover is disposed below the floor of the main body to delimit and underside of the cooling gallery.

8. The battery casing module assembly of claim 6, wherein the cooling gallery is structured to have a cold cooling fluid line fluidly connected to an inlet thereof and a heated cooling fluid line fluidly connected to an outlet thereof.

9. The battery casing module assembly of claim 1, further comprising:
a second battery casing module comprising a main body having a floor, a front wall, a rear wall, and two lateral walls delimiting a space therein,
wherein the first battery casing module and the second battery casing module are attached.

10. The battery casing module assembly of claim 9, wherein the floor of the first battery casing module is attached to the floor of the second battery casing module such that the first and second battery casing modules are attached in a vertical direction.

11. The battery casing module assembly of claim 10, wherein a cooling gallery is formed in the floor of the main body of the first battery casing module, and the floor of the main body of the second battery casing module delimits an underside of the cooling gallery.

12. The battery casing module assembly of claim 9, wherein the first battery casing module and the second battery casing module are interlocked in a longitudinal direction.

13. The battery casing module assembly of claim 12,
wherein the second battery casing module comprises:
a first abutting surface formed on a forward surface of the front wall and abutting the second protrusion of the first battery casing module, and
a first protrusion extending forward from the front wall and abutting the second abutting surface of the first battery casing module.

14. The battery casing module assembly of claim 12, further comprising an end cap disposed on a lateral end of the first and second battery casing modules.

15. The battery casing module assembly of claim 10,
wherein a cooling gallery is formed on the floor of the first battery casing module,
wherein a thermal interface material cavity is formed on the floor of the main body of the second battery casing module, and
wherein a thermal interface material is disposed in the thermal interface material cavity.

16. The battery casing module assembly of claim 15, wherein a cooling gallery plate is disposed between the floor of the main body of the first battery casing module and the thermal interface material.

17. The battery casing module assembly of claim 15, wherein a compression limiter is formed on an outer periphery of the thermal interface material cavity.

18. A battery casing module structure, comprising:
a main body having a front wall, a rear wall, two lateral walls, and a central floor delimiting an upper enclosure and a lower enclosure therein configured to accept battery cells;
a first abutting surface formed on a forward surface of the front wall;
a first protrusion extending forward from the front wall;
a second abutting surface formed on a rear surface of the rear wall;
a second protrusion extending rearward from the rear wall;
a third abutting surface formed on the forward surface of the front wall below the first protrusion;
a third protrusion extending forward from the front wall below the third abutting surface;
a fourth protrusion extending rearward from the rear wall below the second abutting surface; and
a fourth abutting surface formed on the rear surface of the rear wall below the fourth protrusion.

19. The battery casing module structure of claim 18, wherein a cooling gallery is formed in the central floor.

20. A battery casing module assembly, comprising:
a first battery casing module, a second battery casing module, a third battery casing module, and a fourth battery casing module,
wherein each of the first and third battery casing modules comprises:
a main body having a floor, a front wall, a rear wall, and two lateral walls delimiting a space therein configured to accept battery cells;
a first abutting surface formed on a forward surface of the front wall;
a first protrusion extending forward from the front wall;
a second abutting surface formed on a rear surface of the rear wall; and
a second protrusion extending rearward from the rear wall,
wherein each of the second and fourth battery casing modules comprises:
a main body having a floor, a front wall, a rear wall, and two lateral walls delimiting a space therein configured to accept battery cells;
a first abutting surface formed on a rear surface of the rear wall;
a first protrusion extending rearward from the rear wall;
a second abutting surface formed on a front surface of the front wall; and
a second protrusion extending forward from the front wall,
wherein the floor of the first battery casing module is attached to the floor of the second battery casing module such that the first and second battery casing modules are attached in a vertical direction,
wherein the floor of the third battery casing module is attached to the floor of the fourth battery casing module such that the third and fourth battery casing modules are attached in the vertical direction,
wherein the first abutting surface of the third battery casing module abuts the second protrusion of the first battery casing module,
wherein the first protrusion of the third battery casing module abuts the second abutting surface of the first battery casing module,
wherein the second abutting surface of the fourth battery casing module abuts the first protrusion of the third battery casing module,
wherein the second protrusion of the fourth battery casing module abuts the first abutting surface of the third battery casing module, and
wherein a first cooling gallery is formed in the floor of the first battery casing module and a second cooling gallery is formed in the floor of the third battery casing module.
